(19) United States
(12) Patent Application Publication
(10) Pub. No.: US 2008/0259013 A1
(43) Pub. Date: Oct. 23, 2008

(54) GAMMA CORRECTION CIRCUIT

(75) Inventor: Hironori Kobayashi, Asahi-mura (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/100,689

(22) Filed: Apr. 10, 2008

(30) Foreign Application Priority Data
Apr. 19, 2007 (JP) 2007-110122

(51) Int. Cl. G09G 3/36

(52) U.S. Cl. 345/89

(57) ABSTRACT

A gamma correction circuit includes: a first set of operational amplifiers each configured as a voltage follower, each of the first set of operational amplifiers including a phase compensation circuit that has a variable current source; and a second operational amplifier configured as a voltage follower, the gamma correction circuit dividing an input voltage so as to generate a plurality of divided voltages, and outputting a plurality of grayscale voltages based on the plurality of divided voltages generated, the first set of operational amplifiers generating a most significant voltage and a least significant voltage of the plurality of grayscale voltages, based on a predetermined divided voltage of the plurality of divided voltages, the second operational amplifier generating an intermediate voltage of the plurality of grayscale voltages, but not the most significant voltage nor the least significant voltage of the grayscale voltages, based on a predetermined divided voltage of the plurality of divided voltages, an output capability of each of the first set of operational amplifiers being larger than an output capability of the second set of operational amplifier, and the variable current source being allowed to change and set a current value to an arbitral value.

The entire disclosure of Japanese Patent Application No. 2007-110122, filed Apr. 19, 2007 is expressly incorporated by reference herein.

### BACKGROUND

1. Technical Field

The present invention relates to a gamma (γ) correction circuit, for instance, to the one that produces a grayscale voltage corresponding to a gamma characteristic of a display device.

2. Related Art

A common gamma correction circuit includes, for instance, as shown in FIG. 5, a voltage divider circuit 2 composed of resistors RA1 to RA7, a voltage divider circuit 3 composed of resistors RB1 and RB7, changeover switches SW0 to SW7, operational-amplifiers (op-amps) OP0 to OP7 that constitute a voltage follower, and resistors RC1 to RC5 provided on an output side of the circuit. Moreover, smoothing capacitors C1 and C2 having a relatively large capacity are provided in order to reduce the oscillation of the op-amps OP0 and OP7.

Here, as shown in FIG. 6, the resistors RA1 to RA7 and the resistors RB1 to RB7 each include a selector and a resistor having intermediate taps, and one of the intermediate taps can be selected by the selector. The overall resistance of the resistors RA1 to RA7 is equal to that of the resistors RB1 to RB7.

This gamma correction circuit allows the selective use of the voltage divider circuits 2 and 3, by switching between the changeover switches SW0 to SW7.

A grayscale voltage V0 obtained from the op-amp OP0 has a voltage VDD supplied from a grayscale power source 1, when using any of the voltage divider circuits 2 and 3. Similarly, a grayscale voltage V63 obtained from the op-amp OP7 has a voltage VSS, when using any of the voltage divider circuits 2 and 3. On the other hand, the grayscale voltages V1 to V62, obtained from output terminals of the op-amps OP1 to OP6 as well as from the intermediate taps of the resistors RC1 to RC5, have different set of values, depending on which one of the voltage divider circuits is selected, i.e. the voltage divider circuit 2 composed of the RA1 to RA7, or the voltage divider circuit 3 composed of the RB1 to RB7.

In the gamma correction circuit shown in FIG. 5, the grayscale voltage V0 stays at the voltage VDD, and the grayscale voltage V63 stays at the voltage VSS, when using any of the voltage divider circuits 2 and 3. The grayscale voltages V1 to V62 are changeable, while the grayscale voltages V0 and V63 remain fixed, when selectively using the voltage divider circuits 2 and 3. Therefore, it is desirable that the grayscale voltages V0 and V63 be also changeable, not only the grayscale voltages V1 to V62, even when any one of the voltage divider circuits 2 and 3 are being used.

The common gamma correction disclosed in JP-A-2005-10276 is known as another example of a common gamma correction circuit.

The gamma correction circuit according to JP-A-2005-10276 includes a plurality of gamma correction resistors provided at the input side of the circuit, another plurality of gamma correction resisters provided at the output side of the circuit, and a plurality of op-amps provided therebetween. Among the plurality of gamma correction resistors at the input side, the ones in the vicinity of the input voltage are variable resistors, and others are fixed resistors. Similarly, among the plurality of gamma correction resistors at the output side, the ones in the vicinity of the input voltage are variable resistors, and others are fixed resistors.

In the gamma correction circuit having a structure described above, in order to obtain desired grayscale voltages according to gamma characteristics, the potentials of the op-amps at the input and the output side are equalized by simultaneously modifying the gamma correction resistors at both the input side and the output side. Consequently, an excessive current is prevented from flowing between the gamma correction resisters and the op-amps, and the consumption current is reduced, thereby stable grayscale voltages are produced.

As described, the gamma correction circuit described in JP-A-2005-10276 reduces the consumption current when the desired grayscale voltages are obtained according to gamma characteristics, while modification of the gamma correction resistors is required at both the input side and the output side every time.

Based on this background, in the case of obtaining a desired grayscale voltages such as two types of grayscale voltages while taking advantage of the gamma correction circuit shown in FIG. 5, a novel gamma correction circuit is desired for reducing the consumption current and achieving power saving, without using capacitors, while reducing the oscillation of the op-amps.

### SUMMARY

An advantage of the invention is to provide, without using capacitors, a gamma correction circuit that allows reducing the consumption current and achieving power saving, while reducing the oscillation of the op-amps, in the case of obtaining a desired grayscale voltage.

In order to achieve this advantage, an aspect of the present invention is provided in the following configuration.

According to the invention, a gamma correction circuit includes: a first set of operational amplifiers each configured as a voltage follower, each of the first set of operational amplifiers including a phase compensation circuit that has a variable current source; and a second operational amplifier configured as a voltage follower. Here, the gamma correction circuit divides an input voltage so as to generate a plurality of divided voltages, and outputs a plurality of grayscale voltages based on the plurality of divided voltages generated. Further, the first set of operational amplifiers generates a most significant voltage and a least significant voltage of the plurality of grayscale voltages, based on a predetermined divided voltage of the plurality of divided voltages. Still further, the second operational amplifier generates an intermediate voltage of the plurality of grayscale voltages, but not the most significant voltage nor the least significant voltage of the grayscale voltages, based on a predetermined divided voltage of the plurality of divided voltages. Moreover, an output capability of each of the first set of operational amplifiers is larger than an output capability of the second operational amplifier; and the variable current source is allowed to change and set a current value to an arbitral value.

In this case, the second operational amplifier includes a set of the second operational amplifiers, and the second set of operational amplifiers includes: a third set of operational amplifiers generating a maximum voltage and a minimum voltage of the intermediate voltages; and a fourth operational amplifier generating a voltage among the intermediate voltages, but not the maximum voltage nor the minimum voltage of the intermediate voltages. An output capability of each of the third set of operational amplifiers is larger than an output capability of the fourth operational amplifier.

In this case, the variable current source includes: a plurality of first transistors each generating a predetermined current, so as to function as a current source; and a plurality of second transistors respectively coupled with each of the plurality of first transistors in series, so as to function as switches. A predetermined bias voltage is applied to gates of the plurality of first transistors, and on-off control signals are applied on gates of the plurality of second transistors.

Therefore, the invention configured as above described allows reducing the consumption current and achieving power saving, while reducing the oscillation of the op-amps, in the case of obtaining a desired grayscale voltage without using capacitors.

### BRIEF DESCRIPTION OF THE DRAWINGS

The invention will be described with reference to the accompanying drawings, wherein like numbers reference like elements.

FIG. 1 is a circuit diagram illustrating a configuration of an embodiment according to an aspect of the invention.

FIG. 2 is a circuit diagram illustrating an example of a specific configuration of the op-amps OP0 and OP7 illustrated in FIG. 1.

FIG. 3 is a circuit diagram illustrating an example of a specific configuration of the op-amps OP1 and OP6 illustrated in FIG. 1.

FIG. 4 is a circuit diagram illustrating an example of a specific configuration of the op-amps OP2 through OP5 illustrated in FIG. 1.

FIG. 5 is a circuit diagram of a common gamma correction circuit.

FIG. 6 is a drawing illustrating a structure of a resistor used in a voltage divider circuit.

### DESCRIPTION OF PREFERRED EMBODIMENTS

An embodiment of the invention will now be described with references to the accompanying drawings.

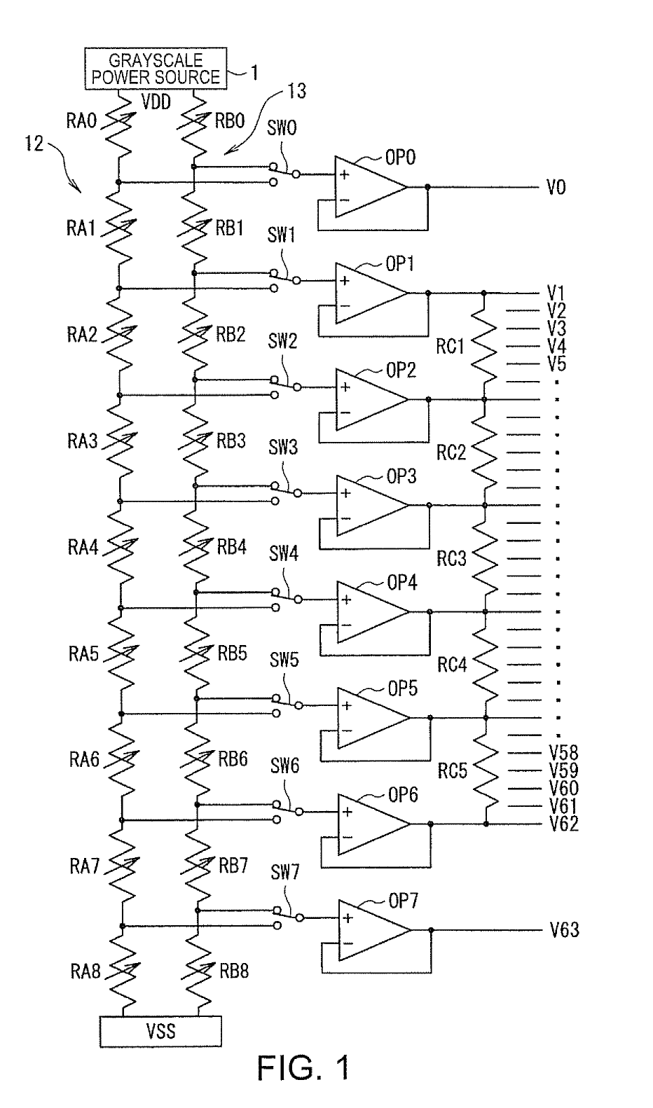

As shown in FIG. 1, this embodiment of a gamma correction circuit according to the aspects of the invention includes voltage divider circuits 12 and 13 provided on an input side of the circuit, a plurality of changeover switches SW0 to SW7, a plurality of op-amps OP0 to OP7 that constitute a voltage follower, and a plurality of resistors RC1 to RC5 provided on an output side of the circuit.

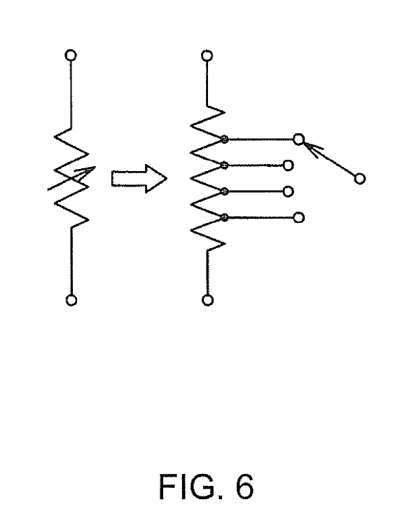

Here, as shown in FIG. 6, resistors RA0 to RA8 and resistors RB0 to RB8 each include a selector and a resistor element that has intermediate taps, and one of the intermediate taps can be selected by the selector. The overall resistance of the resistors RA0 to RA8 is equal to that of the resistors RB0 to RB8.

The voltage divider circuit 12 includes a series circuit in which the resistors RA0 to RA8 are coupled in series. The voltage divider circuit 13 includes a series circuit in which the resistors RB0 to RB8 are coupled in series. One end of each of the voltage divider circuits 12 and 13 receives the voltage VDD as an input voltage supplied from the grayscale power source 1, and other end of each of the voltage divider circuits 12 and 13 receives the voltage VSS as an input voltage.

The changeover switches SW0 to SW7 select divided voltages of the voltage divider circuits 12 and 13, and supply these selected divided voltages to the op-amps OP0 to OP7. Normally, the changeover switches SW0 to SW7 select and output the divided voltage of the voltage divider circuit 13, as shown in FIG. 1.

If the changeover switches SW0 to SW7 select the divided voltages of the voltage divide circuit 12, then the plurality of the op-amps OP0 to OP7 constituting the voltage follower output the divided voltages of the voltage divider circuit 12 as a first set of grayscale voltages V0 to V63. If the changeover switches SW0 to SW7 select the divided voltages of the voltage divide circuit 13, then those divided voltages are output as a second set of grayscale voltages V0 to V63 that are different from the first set.

The plurality of resistors RC1 to RC5 couples the output terminal of one of the op-amps OP1 to OP6 to another. These resistors RC1 to RC5 each include the intermediate taps which subdivide the grayscale voltages V1 to V62.

No resistor is coupled between the output terminals of the op-amp OP0 and the op-amp OP1, nor between the output terminals of the op-amp OP62 and the op-amp OP63. This prevents the current from flowing into the op-amps OP1 to OP62 in a drive mode in which only the op-amps OP0 and OP63 are driven.

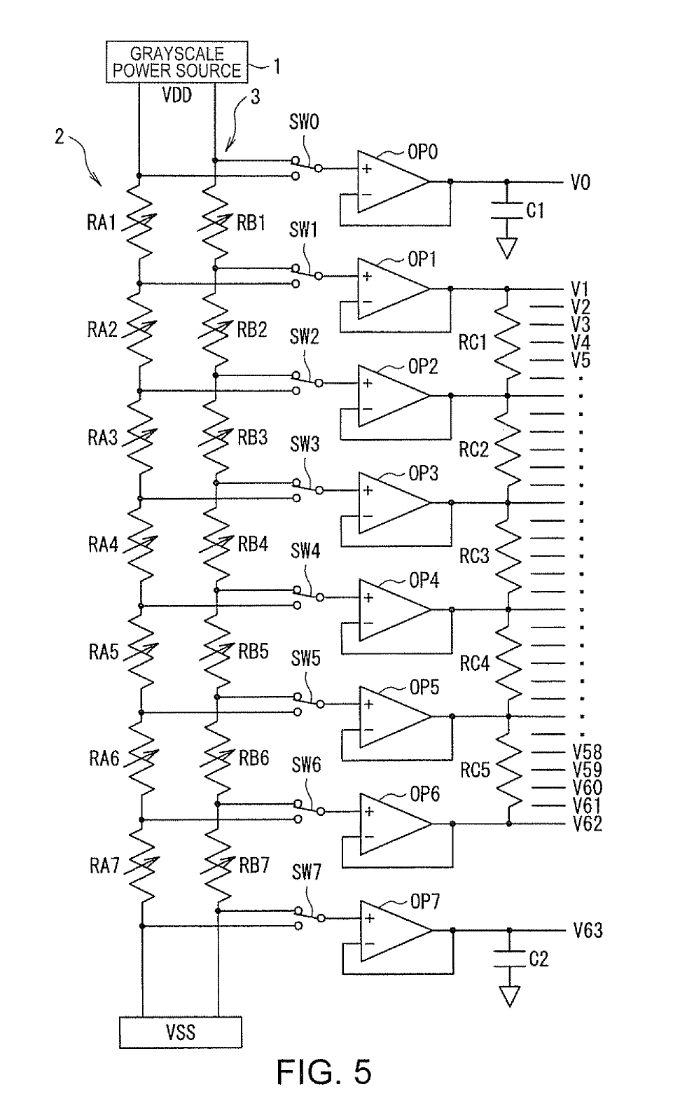

In this embodiment, the resistors RA0 and RA8 are included in the voltage divider circuit 12, and the resistors RB0 and RB8 are included in the voltage divider circuit 13. Consequently, the voltage divider circuit 12 and the voltage divider circuit 13 produce different sets of grayscale voltages V0 and V63, by selecting the intermediate taps of the resistors RA0 and RA8. If, in this embodiment, the capacitors C1 and C2 are present and are coupled to the output terminals of the op-amps OP0 and OP7, similar to the configuration shown in FIG. 5, the different sets of grayscale voltages V0 and V63 of those voltage divider circuits 12 and 13 cause the input voltage of the op-amps OP0 and OP7 to fluctuate when switching between the voltage divider circuits 12 and 13. As a result, the output voltages of the op-amps OP0 and OP7 also fluctuate, causing the current to flow into the capacitors C1 and C2, resulting in wastage in power consumption.

Therefore, in this embodiment, unlike the configuration shown in FIG. 5, the capacitors C1 and C2 are not used at the output terminals of the op-amps OP0 and OP7. Instead, those op-amps OP0 to OP7 are set to have different output capabilities, in order to reduce the wastage in power consumption. The description thereof follows.

The output capabilities of the op-amps OP0 to OP7 are the indicators of voltage levels (voltage values) of their self-output voltages within the voltage range of power voltages (input voltages) VDD and VSS used in the voltage divider circuits 12 and 13.

The op-amps OP0 and OP7 both have the largest output capabilities, respectively outputting the most significant voltage (V0) and the least significant voltage (V63) of the grayscale voltages V0 to V63, so that the values of the output voltages thereof become close to that of the power voltages VDD and VSS used in the voltage divider circuits 12 and 13. The output capabilities of the op-amps OP1 to OP6 that output intermediate voltages V1 to V62 are set to have the output capabilities smaller than those of the op-amps OP0 and OP7.

Moreover, the op-amps OP1 to OP6 are configured so that the op-amps OP1 and OP6 both have the largest output capabilities, the op-amps OP1 and OP6 generating the maximum voltage V1 and the minimum voltage V62 of the intermediate voltages V1 to V62. Other op-amps OP2 to OP5 are set to have the output capabilities smaller than those of the op-amps OP1 and OP6.

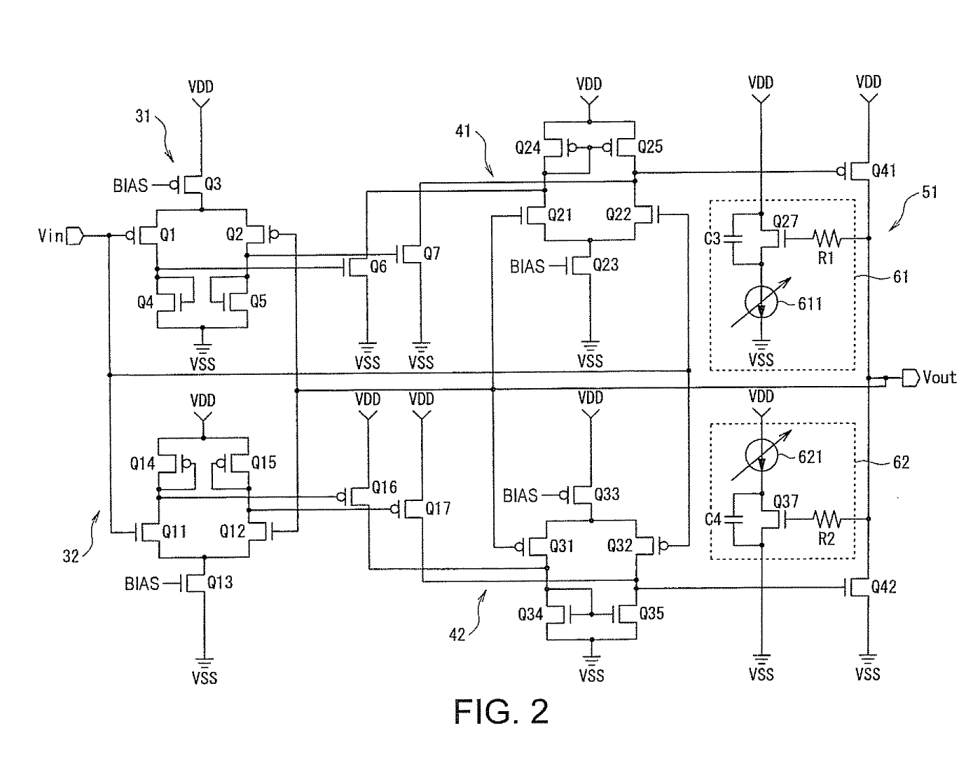

Hereafter, the specific configuration of the op-amps OP0 to OP7 sorted according to their output capabilities will be described while referring to FIGS. 2 to 4.

Each of the op-amps OP0 and OP7 illustrated in FIG. 1 has a configuration described in FIG. 2.

Each of these op-amps includes, as shown in FIG. 2, a first input unit 31, a second input unit 32, a first intermediate unit 41, a second intermediate unit 42, an output unit 51, a first phase compensation circuit 61, and a second phase compensation circuit 62, all of which together constitute a voltage follower.

The first input unit 31 includes p-type MOS transistors Q1 and Q2 which together constitute a differential input pair, a p-type MOS transistor Q3 that functions as a power source, and n-type MOS transistors Q4 and Q5 that function as loads. These together constitute a differential amplifier circuit, The first input unit 31 also includes n-type MOS transistors Q6 and Q7.

The second input unit 32 includes n-type MOS transistors Q11 and Q12 which together constitute a differential input pair, an n-type MOS transistor Q13 that functions as a power source, and p-type MOS transistors Q14 and Q15 that function as loads. These together constitute a differential amplifier circuit. The second input unit 32 also includes p-type MOS transistors Q16 and Q17.

The first intermediate unit 41 includes n-type MOS transistors Q21 and Q22 which together constitute a differential input pair, an n-type MOS transistor Q23 that functions as a power source, and p-type MOS transistors Q24 and Q25 that constitute a current mirror. These together constitute a differential amplifier circuit.

The second intermediate unit 42 includes p-type MOS transistors Q31 and Q32 which together constitute a differential input pair, a p-type MOS transistor Q33 that functions as a power source, and n-type MOS transistors Q34 and Q35 that constitute a current mirror. These together constitute a differential amplifier circuit.

The output unit 51 includes a p-type MOS transistor Q41 and an n-type MOS transistor Q42, and an output voltage Vout is retrieved from a common coupling portion present between those transistors.

The first phase compensation circuit 61 is a circuit that carries out phase compensation in order to prevent an oscillation of the op-amp caused by a feedback circuit included in the op-amp which constitute the voltage follower. As shown in FIG. 2, the first phase compensation circuit 61 includes a capacitor C3, a MOS transistor Q27, a resistor R1, and a variable current source 611.

The variable current source 611 produces a variable current, and the values of the currents can be arbitrarily set, for instance, with an external unit. In other words, the variable current source 611 adjusts the capability of the first phase compensation circuit 61, setting the capability to an arbitral value as needed.

The variable current source 611 therefore generates a predetermined current, and includes a plurality of first transistors that function as a current source, and a plurality of second transistors that function as switches, each of the plurality of second transistors coupled with the plurality of first transistors in series. None of these components are illustrated. A predetermined bias voltage is impressed to the gates of the plurality of first transistors, and on-off control signals are impressed on the gates of the plurality of second transistors, so as to optionally set the current value, depending on the number of second transistors that are switched on.

Similarly, the second phase compensation circuit 62 includes a capacitor C4, a MOS transistor Q37, a resistor R2, and a variable current source 621. The configuration of the variable current source 621 is similar to that of the variable current source 611.

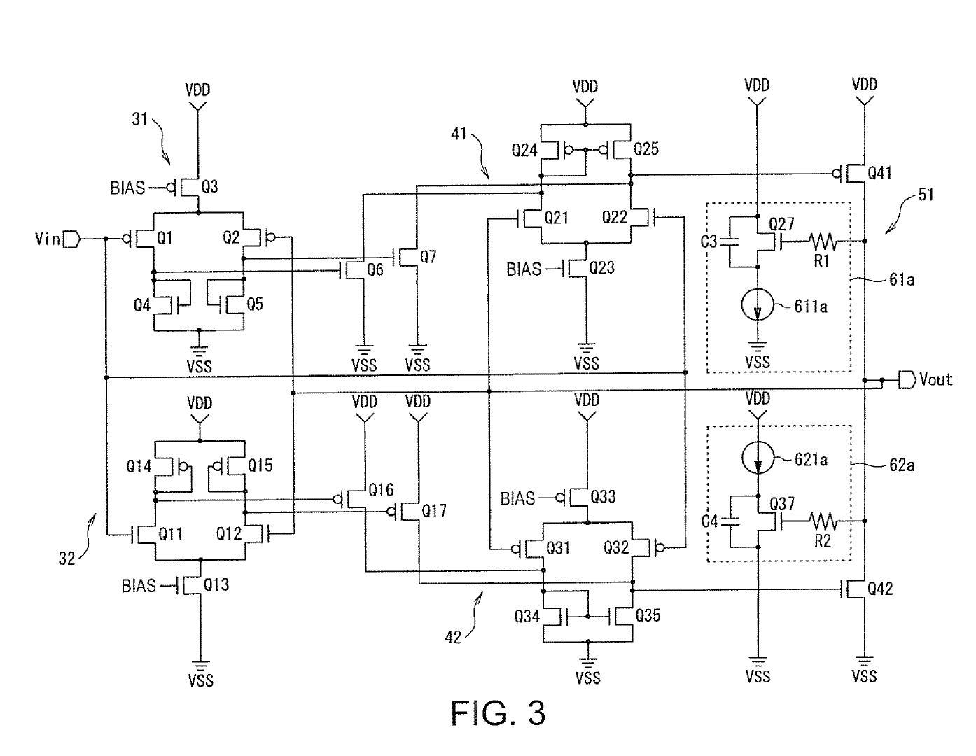

Each of the op-amps OP1 and OP6 illustrated in FIG. 1 has a configuration described in FIG. 3.

Each of these op-amps includes, as shown in FIG. 3, the first input unit 31, the second input unit 32, the first intermediate unit 41, the second intermediate unit 42, the output unit 51, a first phase compensation circuit 61a, and a second phase compensation circuit 62a, all of which together constitute a voltage follower.

These op-amps are substantially similar to that of the configuration illustrated in FIG. 2, except that the first phase-compensation circuit 61 and the second phase compensation circuit 62 are respectively altered with the first phase compensation circuit 61a and the second phase compensation circuit 62a.

The first phase compensation circuit 61a includes, as illustrated in FIG. 3, the capacitor C3, the MOS transistor Q27, the resistor R1, and a fixed current source 611a having a pre-fixed current value. Similarly, the second phase compensation circuit 62a includes the capacitor C4, the MOS transistor Q37, the resistor R2, and a fixed current source 621a having a pre-fixed current value.

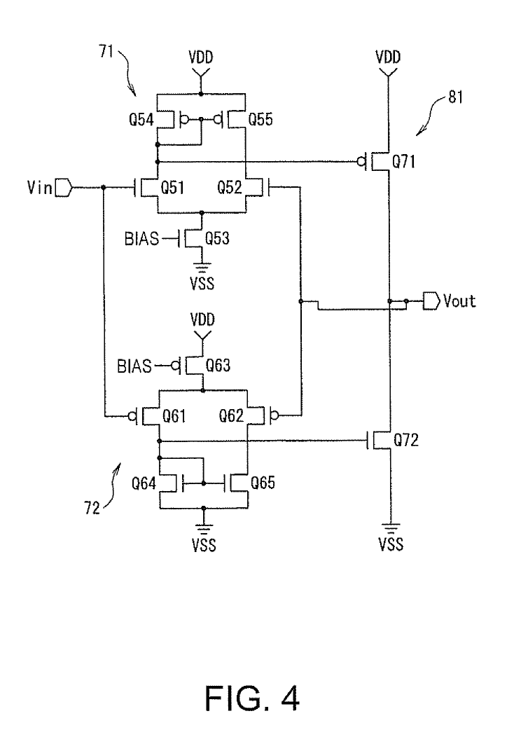

Each of the op-amps OP2 to OP5 illustrated in FIG. 1 has a configuration described in FIG. 4.

Each of these op-amps includes, as shown in FIG. 4, a first input unit 71, a second input unit 72, and an output unit 81, all of which together constitute a voltage follower.

The first input unit 71 includes n-type MOS transistors Q51 and Q52 which together constitute a differential input pair, an n-type MOS transistor Q53 that functions as a power source, and p-type MOS transistors Q54 and Q55 that constitute a current mirror. These together constitute a differential amplifier circuit.

The second input unit 72 includes p-type MOS transistors Q61 and Q62 which together constitute a differential input pair, a p-type MOS transistor Q63 that functions as a power source, and n-type MOS transistors Q64 and Q65 that constitute a current mirror. These together constitute a differential amplifier circuit.

The output unit 81 includes a p-type MOS transistor Q71 and an n-type MOS transistor Q72, and the output voltage Vout is retrieved from a common coupling portion present between those transistors.

As described, in this embodiment, the resistors RA0 and RA8 are included in the voltage divider circuit 12, and the resistors RB0 and RB8 are included in the voltage divider circuit 13. Consequently, not only the grayscale voltages V1 to V62 but also the grayscale voltages V0 and V63 become changeable. Therefore, in the case of switching between the voltage divider circuits 12 and 13 during their use, two different sets of grayscale voltages, i.e. the most significant voltage V0 (maximum value) and the leas significant voltage V63 (minimum value), are generated.

Moreover, according to this embodiment, the output capabilities of the op-amps OP0 and OP7 are relatively larger than those of the op-amps OP1 to OP6, and the op-amps OP0 and OP7 respectively include the first phase compensation circuit 61 that has the variable current source 611, and the second phase compensation circuit 62 that has the variable current source 621. This prevents the oscillation of the op-amps OP0 and OP7 without using the capacitors C1 and C2 shown in FIG. 5.

Therefore, this embodiment allows reducing, without using capacitors, the consumption current as well as achieving power saving, while reducing the oscillation of the op-amps, in the case of obtaining two types of grayscale voltages.

What is claimed is:

1. A gamma correction circuit, comprising:
a first set of operational amplifiers each configured as a voltage follower, each of the first set of operational amplifiers including a phase compensation circuit that has a variable current source; and
a second operational amplifier configured as a voltage follower,
the gamma correction circuit dividing an input voltage so as to generate a plurality of divided voltages, and outputting a plurality of grayscale voltages based on the plurality of divided voltages generated,
the first set of operational amplifiers generating a most significant voltage and a least significant voltage of the plurality of grayscale voltages, based on a predetermined divided voltage of the plurality of divided voltages,
the second operational amplifier generating an intermediate voltage of the plurality of grayscale voltages, but not the most significant voltage nor the least significant voltage of the grayscale voltages, based on a predetermined divided voltage of the plurality of divided voltages,
an output capability of each of the first set of operational amplifiers being larger than an output capability of the second operational amplifier, and
the variable current source being allowed to change and set a current value to an arbitral value.

2. The gamma correction circuit according to claim 1, wherein the second operational amplifier includes a set of second operational amplifiers, and the second set of operational amplifiers includes:
a third set of operational amplifiers generating a maximum voltage and a minimum voltage of the intermediate voltages; and
a fourth operational amplifier generating a voltage among the intermediate voltages, but not the maximum voltage nor the minimum voltage of the intermediate voltages, an output capability of each of the third set of operational amplifiers being larger than an output capability of the fourth operational amplifier.

3. The gamma correction circuit according to claim 1, wherein the variable current source includes:
a plurality of first transistors each generating a predetermined current, so as to function as a current source; and
a plurality of second transistors respectively coupled with each of the plurality of first transistors in series, so as to function as switches, a predetermined bias voltage being applied to gates of the plurality of first transistors, and on-off control signals being applied on gates of the plurality of second transistors.
